(19) United States
(12) Patent Application Publication
(10) Pub. No.: US 2005/0061136 A1
(43) Pub. Date: Mar. 24, 2005

(54) Multi-tonal ligature

(76) Inventor: Philip L. Rovner, Timonium, MD (US)

Correspondence Address: Royal W. Craig;Law Offices of Royal W. Craig, Suite 153, 10 N. Calvert Street, Baltimore, MD, 21202, US

(21) Appl. No.: 10/667,713

(22) Filed: Sep. 22, 2003

(51) Int. Cl. G10D 7/00

(52) U.S. Cl. 84/383 A; 84/380 R

(57) ABSTRACT

An improved ligature is provided for use on a mouthpiece of a woodwind-type musical instrument. The ligature comprises a flexible, trapezoidal body having two longitudinal slots, and a pair of ferrules terminating each end of the body. The body is a rubberized fabric with one side being smooth and the other defined by a textured pattern. A tightening mechanism draws the ferrules together and thereby tightens the flexible body about the mouthpiece of the instrument. Each of the ferrules is formed with a longitudinal notch, and the ends of the body terminate inside by crimping and/or gluing the body end inside. The operation of the tightening mechanism within the ferrules in combination with the flexible nature of the body serve to effectively isolate the instrument mouthpiece from direct contact with the ferrules, thereby improving tonal response. The instrument's tonality may be adjusted by placing the smooth or textured side of the body in direct contact with the instrument and varying the relative position of the body and ferrules with respect to the reed.

### BACKGROUND OF THE INVENTION

1. Field of the Invention

The present invention relates to ligatures for woodwind musical instruments and, more particularly, to a ligature which facilitates the generation of multiple tonalities by a single instrument.

2. Description of the Background

Ligatures are used to mount a vibrating reed element to the surface of a mouthpiece for an instrument such as a clarinet or saxophone. One goal of ligature design is to permit maximum freedom of vibration of the reed because this improves resonance, and hence tonality. There have been prior ligatures that attempt to provide an adjustable quality of tone or response by utilizing screw adjustments, as in the designs of Van Doren U.S. Pat. No. 5,419,229 and Cusack U.S. Pat. No. 5,456,152, or sliding bars as in Pascucci U.S. Pat. No. 3,791,253, or a plurality of pressure pins as in Winslow U.S. Pat. No. 4,428,271. However, those using pressure adjustments may not achieve satisfactory performance throughout the full range of adjustment. The present inventor suggested a design for an adjustable-tone ligature in his U.S. Pat. No. 5,998,715 issued Dec. 7, 1999. The '715 patent described a ligature with a flexible or semi-flexible body and cradle connected to the inside of the body. Alteration in tone and response are achieved by changing the virtual mass of the cradle.

It has since been found that a ligature construction that tends to neutralize or move resonances away from the operating bandwidth of the instrument tends to improve performance. The inventor's '715 patent suggests a body that is wrapped about two rods, the rods being drawn together to tighten the body around the instrument. The wrapped configuration results in a hard (abrupt) termination of the body which presents a high mechanical impedance for the ligature ends. It would be greatly advantageous to provide a ligature design with a “soft” termination, or in other terms, a lower mechanical impedance for the ligature ends, thus lowering the frequency bandwidth of the predominant resonances. This would result in an adjustable-tone ligature that facilitates the generation of multiple, full, resonant tonalities by a single instrument.

### SUMMARY OF THE INVENTION

It is, therefore, an object of the present invention to provide a ligature which permits a variety of tonal effects and differences in response to be obtained rapidly with a minimum of manipulations.

It is another object of the present invention to provide an adjustable-tone ligature with a “soft” termination and lower mechanical impedance for the ligature ends, thus lowering the frequency bandwidth of the predominant resonances.

Yet another object of the present invention is to provide an adjustable-tone ligature that facilitates the generation of multiple, full, resonant tonalities by a single instrument.

Still another object of the present invention is to provide an adjustable-tone ligature that may be economically produced to provide for widespread use.

In accordance with the above objects, an improved ligature is provided for use on a mouthpiece of a woodwind-type musical instrument (of the type having a reed). The ligature possesses a simple design that may be economically produced to provide for widespread use. The present invention comprises a flexible, trapezoidal body having two longitudinal slots, and a pair of ferrules terminating each end of the body. The body is a rubberized fabric with one side being smooth and the other defined by a textured pattern. A tightening mechanism draws the ferrules together and thereby tightens the flexible body about the mouthpiece of the instrument. Each one of the ferrules is formed with a longitudinal notch, and the ends of the body terminate inside by crimping and/or gluing the body end inside. The operation of the tightening mechanism within the ferrules in combination with the flexible nature of the body serve to effectively isolate the instrument mouthpiece from direct contact with the ferrules, thereby softening the mechanical impedance. The instrument's tonality may be adjusted by placing either the smooth or the textured side of the body in direct contact with the instrument, and varying the relative position of the body and ferrules with respect to the reed.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a perspective view of an improved ligature 10 according to a preferred embodiment of the present invention.

FIG. 2 is a top view of the ligature 10 of FIG. 1.

FIG. 3 is an end view of the ligature 10 of FIGS. 1 and 2.

FIG. 4 is a side view of the ligature 10 of FIGS. 1-3.

FIG. 5 is a perspective view of a mouthpiece 100 of a woodwind-type musical instrument showing the ligature 10 of FIGS. 1-4 attached thereto in the first of three tonal adjusting positions.

FIG. 6 is a perspective view of a mouthpiece 100 of a woodwind-type musical instrument showing the ligature 10 of FIGS. 1-4 attached thereto in the second of three tonal adjusting positions.

FIG. 7 is a perspective view of a mouthpiece 100 of a woodwind-type musical instrument showing the ligature 10 of FIGS. 1-4 attached thereto in the third of three tonal adjusting positions.

FIG. 8 is a top, flat pattern view of a flexible body 18 showing its trapezoidal shape, longitudinal slots 19, web section 20, and attached ferrules 22.

### DETAILED DESCRIPTION OF THE PREFERRED EMBODIMENTS

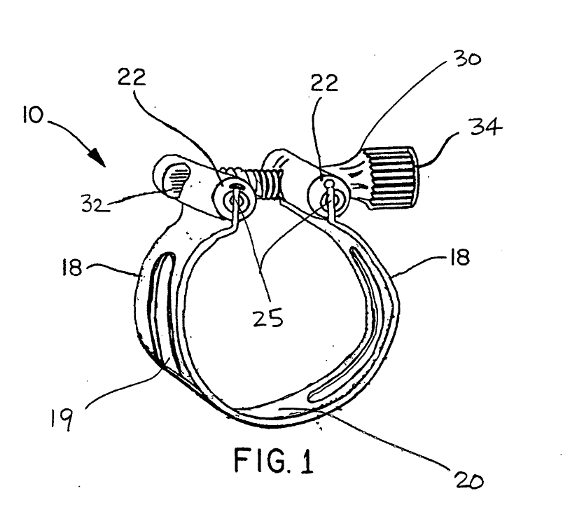

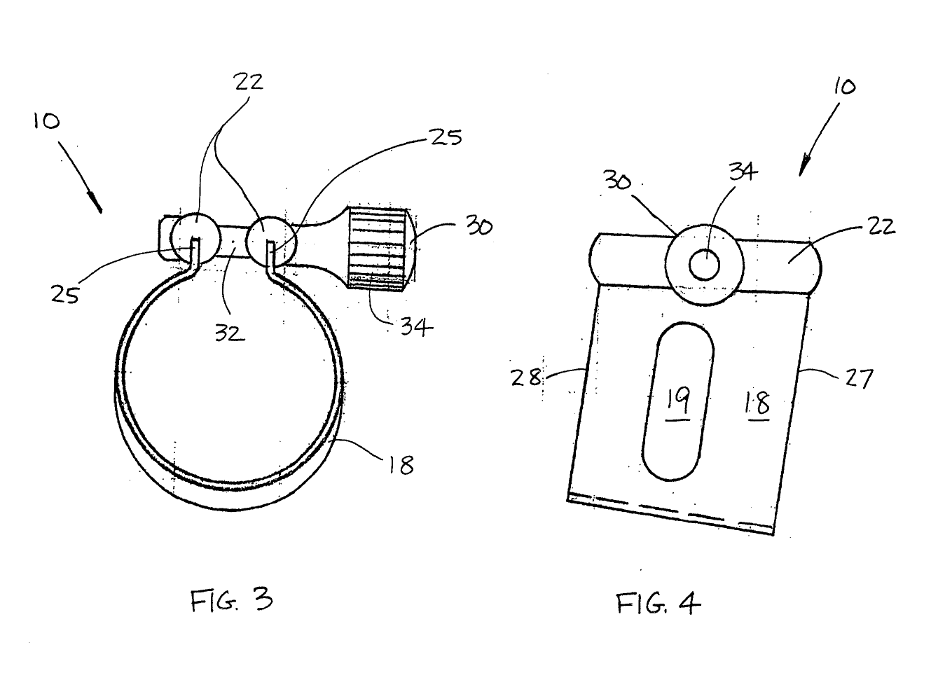

FIGS. 1-4 are, respectively, perspective, top, end, and side views of an improved ligature 10 according to the present invention. The ligature 10 of the present invention is intended for use on the mouthpiece of any woodwind type musical instrument having a reed, such as a clarinet or a saxophone. FIGS. 5-7 show the mouthpiece 100 of a musical instrument with the ligature 10 attached thereto in a series of tonal adjusting positions.

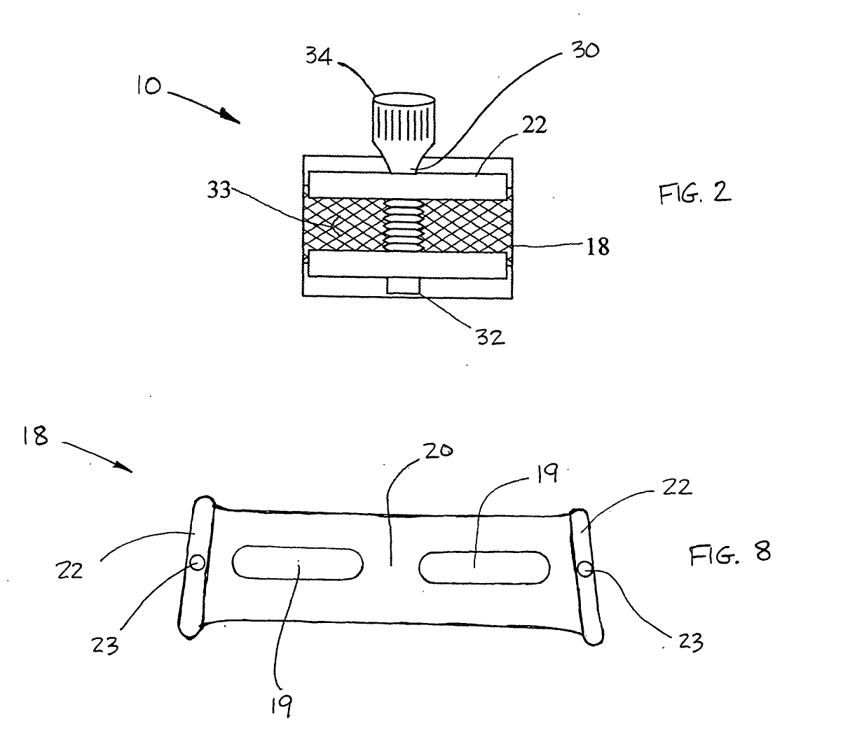

The ligature 10 has a flexible body 18 formed, as shown in FIG. 8, from a trapezoidal-shaped section of flexible rubberized, or plasticized, fabric with one side being smooth and the other defined by a textured pattern 33. FIG. 2's top view of the ligature 10 illustrates the textured surface 33 of the body 18. The textured surface 33 is defined by a shallow crisscross or similar pattern which assists in making the contact area between an instrument and the body 18 more compliant. Compliance serves to cushion the ligature's contact with the reed 110 (see FIGS. 5-7) and the mouthpiece 100, thereby increasing vibration and improving the instrument's tone and response. The body 18 is defined by two longitudinal slots 19 formed end-to-end and a web section 20 located between the slots 19. The ends of the body 18 terminate inside longitudinal notches 25 in corresponding ferrules 22, one ferrule 22 being disposed at each end of the body 18. Each ferrule 22 is a short, rigid, metallic cylindrical member with a transverse through hole 23 (see FIG. 8) positioned at the midpoint of its length and perpendicular to the longitudinal notch 25. In use, as described below, the body 18 is arced back upon itself to form a “C” shaped configuration.

A tightening mechanism 30 cooperates with the holes 23 in each of the ferrules 22 such that rotation of the mechanism 30 varies the spacing between the ferrules 22 in order to open or close the flexible body 18 when fastening the ligature 10 to a mouthpiece 100. The tightening mechanism 30 typically includes a metallic, threaded fastening stud 32, extending through the hole 23 in one ferrule 22, which is rotatably held captive and threads into an elongated, metallic thumb nut 34 after extending through the hole 23 in the second ferrule 22. Other adjustable clamps and fastening means known to persons skilled in the art may be used in place of the tightening mechanism 30 to secure the ligature 10 to the mouthpiece 100.

As stated above and shown in FIG. 8, the ends of the body 18 terminate inside the respective ferrules 22. It has been found that the ferrules 22 form a termination for vibrational energy that exists in the ligature body 18 when sound is being produced in an instrument. If the ferrules 22 are rigidly constrained, the energy will be reflected back into the ligature 10, thereby supporting resonances in the ligature 10 that will degrade its performance. Consequently, it is a design goal of the present invention to provide a soft, or insulated, termination. This is best accomplished by forming ferrules 22 with notches 25 therein to receive the ends of body 18, and by gluing and/or crimping the ends of the body 18 into the ferrules 22 for a secure termination. The operation of the tightening mechanism 30 within the ferrules 22 (i.e. the perpendicular orientation between the notches 25 in the ferrules 22 where the body 18 terminates and the holes 23 in the ferrules 22 through which the tightening mechanism 30 extends) in combination with the flexible nature of the body 18 serve to effectively isolate the instrument mouthpiece 100 from direct contact with the ferrules 22, thereby improving tonal response. When wrapped around a mouthpiece 100, the bend of the body 18 where its ends enter the notches 25 in the ferrules 22 introduces a slight clearance and effectively holds the ferrules 22 a short distance away from the mouthpiece 100. Thus, the ferrules 22 are supported by the material of the body 18 and not the mouthpiece 100. The spacing, or isolation, between the ferrules 22 and the mouthpiece 100 reduces the termination impedance of the ligature 10 and improves tone and response. With the ferrules 22 thus insulated, or softly suspended, the frequency bandwidth of resonance in the ligature body 18 is lowered resulting in an improvement in an instrument's tone, power, and response.

The ligature 10 is mounted around the mouthpiece 100 of a musical instrument to hold a reed 110 in place. No tools are required and no screws, pins or other means need to be added or removed to prepare and install the ligature 10 for use. After orienting the body 18 and engaging the fastening stud 32 with the thumb nut 34, the user simply slides the ligature 10 over the mouthpiece 100 and reed 110 before making final adjustments to the tightening mechanism 30 to secure the ligature 10 around the mouthpiece 100 and reed 110. Changes may be made by loosening the tightening mechanism 30 and changing the relative position of the body 18 with respect to the reed 110 as desired and re-securing the tightening mechanism 30. Note that, due to the trapezoidal shape of the flexible body 18, the final form of the ligature 10, when the tightening mechanism 30 has been installed through the ferrules 22 (the C-shape mentioned above), tapers from a larger diameter end 27 to a smaller diameter end 28 (see FIG. 4). This tapered form is required to facilitate an appropriate fit between the ligature 10 and the tapered shape of the mouthpiece 100 that can be seen in FIGS. 5-7.

The present invention provides a total of six ligature 10 installation positions. The six variations are the product of the three ligature-to-reed/mouthpiece positions illustrated in FIGS. 5-7 combined with the two surface conditions, smooth or textured, found on the flexible body 18. As indicated above, an instrument's tonality may be adjusted by placement of the textured 33 side (see FIG. 2) of the body 18 in direct contact with the mouthpiece 100 and reed 110, resulting in a tonality that is slightly different than that achieved when the smooth side is used. Typically, a softer, warmer tone is achieved when the textured 33 side is placed in direct contact with the mouthpiece 100 and reed 110.

FIG. 5 shows the ligature 10 installed in a manner that places the web 20 of the body 18 directly over the reed 110. The web-over-reed position provides the maximum coverage of the reed 110 by the ligature 10 and results in a darker, warmer tone.

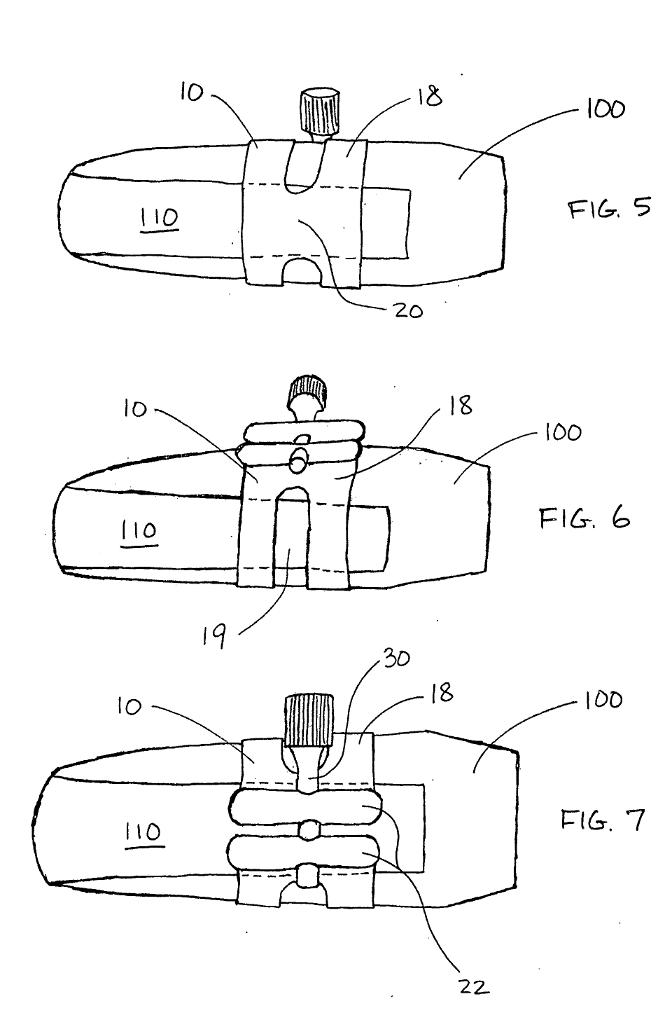

FIG. 6 shows the ligature 10 installed in a manner that places one of the longitudinal slots 19 of the body 18 directly over the reed 110. The slot-over-reed position provides an intermediate degree of coverage of the reed 110 by the ligature 10 and results in a brighter, more free-playing tone.

FIG. 7 shows the ligature 10 installed in a manner that places the ferrules 22 and tightening mechanism 30 directly over the reed 110. The ferrules-over-reed position provides a minimal amount of coverage of the reed 110 by the ligature 10 and results in a more solid, more controlled sound.

The foregoing design results in an adjustable-tone ligature 10 that facilitates the generation of multiple tonalities by a single instrument. Additionally, the present invention also provides a greater degree of responsiveness and richness of tone, from a woodwind instrument, than has previously been realized. Finally, it is a design that may be economically produced to provide for widespread use.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

1. A ligature for use on a mouthpiece of a woodwind type musical instrument having a reed, the ligature comprising:
a flexible body formed as a unitary strip with first and second ends;
a first ferrule, said first end of said flexible body terminating inside said first ferrule;
a second ferrule, said second end of said flexible body terminating inside said second ferrule; and
a tightening mechanism for drawing said first and second ferrules together, thereby tightening said flexible body around said mouthpiece of said musical instrument;
whereby said musical instrument's tonality is varied due to the relative position of said body, said first and second ferrules, said mouthpiece, and said reed.

2. The ligature for use on a mouthpiece of a woodwind type musical instrument according to claim 1, wherein said flexible body is trapezoidal-shaped and defined by two longitudinal slots and a web section positioned between said slots.

3. The ligature for use on a mouthpiece of a woodwind type musical instrument according to claim 2, wherein said two longitudinal slots are positioned end-to-end.

4. The ligature for use on a mouthpiece of a woodwind type musical instrument according to claim 1, wherein said body is fabricated of a rubberized fabric.

5. The ligature for use on a mouthpiece of a woodwind type musical instrument according to claim 4, wherein a first side of said rubberized fabric is defined by a textured pattern.

6. The ligature for use on a mouthpiece of a woodwind type musical instrument according to claim 4, wherein a second side of said rubberized fabric is smooth.

7. The ligature for use on a mouthpiece of a woodwind type musical instrument according to claim 1, wherein said flexible body is formed into a “C” shape for installation on said mouthpiece.

8. The ligature for use on a mouthpiece of a woodwind type musical instrument according to claim 1, wherein each of said first and second ferrules is formed with a longitudinal notch, and said first and second ends of said flexible body terminate inside, respectively, said first and second ferrules by insertion of said body end into said notch and attaching said ferrule thereon.

9. The ligature for use on a mouthpiece of a woodwind type musical instrument according to claim 8, wherein means for attaching said ferrule is crimping.

10. The ligature for use on a mouthpiece of a woodwind type musical instrument according to claim 8, wherein means for attaching said ferrule is gluing.

11. The ligature for use on a mouthpiece of a woodwind type musical instrument according to claim 1, wherein said first and second ferrules are suspended outwardly from said instrument by cooperation of said first and second ends of said flexible body, said first and second ferrules, and said tightening mechanism.

12. The ligature for use on a mouthpiece of a woodwind type musical instrument according to claim 1, wherein each of said first and second ferrules further comprises a transverse through hole.

13. The ligature for use on a mouthpiece of a woodwind type musical instrument according to claim 12, wherein said tightening mechanism comprises a threaded fastening stud extending through said transverse through holes in said first and second ferrules and threaded into a thumb nut.
